(19) United States
(12) Patent Application Publication
(10) Pub. No.: US 2013/0115582 A1
(43) Pub. Date: May 9, 2013

(54) AFFECT BASED CONCEPT TESTING

(71) Applicant: Affectiva, Inc., Waltham, MA (US)

(72) Inventors: Rana el Kaliouby, Waltham, MA (US); Andrew Edwin Dreisch, San Jose, CA (US); Avril England, Pleasanton, CA (US); Evan Kodra, Waltham, MA (US)

(73) Assignee: AFFECTIVA, INC., Waltham, MA (US)

(21) Appl. No.: 13/728,303

(22) Filed: Dec. 27, 2012

Related U.S. Application Data
(63) Continuation-in-part of application No. 13/153,745, filed on Jun. 6, 2011.
(60) Provisional application No. 61/580,880, filed on Dec. 28, 2011.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.

(51) Int. Cl. G09B 19/00

(52) U.S. Cl. CPC G09B 19/00
USPC 434/237

(57) ABSTRACT

Analysis of mental states pertaining to concept testing is described. Concepts may be evaluated by seeing a product, seeing a service, seeing a model, viewing an advertisement, and the like. Data which includes facial information is captured for viewers of a concept. Facial and physiological information is gathered for a group of viewers. Demographic information is collected and used as a criterion for evaluating the concept. Data captured from an individual viewer or group of viewers is used to optimize a concept.

### RELATED APPLICATIONS

This application claims the benefit of U.S. provisional patent application “Affect Based Concept Testing” Ser. No. 61/580,880, filed Dec. 28, 2011. This application is also a continuation-in-part of U.S. patent application “Mental State Analysis Using Web Services” Ser. No. 13/153,745, filed Jun. 6, 2011 which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Data Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. The foregoing applications are hereby incorporated by reference in their entirety.

### FIELD OF ART

This application relates generally to concept testing and more particularly to affect-based concept testing of a product, service, advertisement, or model.

### BACKGROUND

Evaluation of mental states is key to understanding people and the way in which they react to the world around them. People's mental states may run a broad gamut from happiness to sadness, from contentedness to worry, and from excited to calm, among numerous other mental states. These mental states are experienced in response to everyday events such as frustration during a traffic jam, boredom while standing in line, and impatience while waiting for a cup of coffee. Individuals may become rather perceptive and empathetic to those around them based on evaluating and understanding others' mental states. While an empathetic person may, with ease, perceive another person's mental state, whether anxious, joyful, or sad, and respond accordingly, automated evaluation of mental states is a far more challenging undertaking A person may feel that they perceive another's emotional state quickly and instinctually, with a minimum of conscious effort. Thus, the ability and manner by which a person identifies another person's mental state may be difficult to summarize or communicate.

Confusion, concentration, and worry may be identified by various means in order to aid in the understanding of the mental states of an individual or group of people as they react to a visual stimulus. For example, people can collectively respond to a visual stimulus with fear or anxiety, such as may be the case after witnessing a catastrophe. Likewise, people can collectively respond to another type of visual stimulus with happy enthusiasm, such as when their sports team wins a major victory. To aid in this classification, certain facial expressions and head gestures may be used to identify a mental state that a person or a group of people is experiencing. In addition, eye tracking may also be used to measure a person or group of people's engagement with a visual stimulus. To a limited extent, the evaluation of mental states based on facial expressions has been automatized. For example, certain physiological conditions—conditions which may provide telling indications of a person's state of mind—are currently used in a crude fashion to indicate mental state, as seen in an apparatus used for polygraph tests.

### SUMMARY

Analysis of mental states may be performed while a viewer or viewers observe a concept or concepts. Analysis of the mental states of the viewers may indicate whether the viewers are or will be favorably disposed to a concept based on the product, service, advertisement, or model described. A computer implemented method for concept evaluation is disclosed comprising: exposing a plurality of people to a concept wherein the exposing includes displaying of a rendering related to the concept on an electronic display; collecting mental state data from a plurality of people as they are exposed to the concept wherein the mental state data comprises facial data; analyzing the mental state data to produce mental state information; and evaluating the concept based on the mental state information.

The method may further comprise presenting a subset of the mental state information in a visualization. The visualization may be presented on a second electronic display. The visualization may further comprise the rendering related to the concept. The exposing may further comprise collecting responses to questions about the concept from the plurality of people. The responses may constitute self reporting and the self reporting is correlated to the mental state data which was collected. The method may further comprise tracking of eyes for the plurality of people who are exposed to the concept. The tracking of the eyes may identify a portion of the rendering on which the eyes are focused. The method may further comprise correlating the mental state data which was collected with the portion of the rendering on which the eyes were focused. The method may further comprise presenting information on the tracking of the eyes in a visualization. The presenting may be accomplished with a bee-swarm representation of the information on the tracking of the eyes. The bee-swarm representation may include a breakout by demographics. The bee-swarm representation may include information on the mental state data. The rendering may include one of a series of images and a video. The evaluating may include prediction of buying likelihood. The evaluating may include identification of demographics, within the plurality of people, to target for the concept. The evaluating may include clustering of the concept based on effectiveness. The method may further comprise optimizing the concept based on the mental state information. The collecting mental state data may further comprise collecting one or more of physiological data and actigraphy data. A webcam may be used to capture one or more of the facial data and the physiological data. The method may further comprise inferring mental states about the concept based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity. The exposing may further comprise viewing an advertisement, seeing a product, seeing a service, and seeing a model.

In embodiments, a computer program product embodied in a non-transitory computer readable medium for concept evaluation may comprise: code for exposing a plurality of people to a concept wherein the exposing includes displaying of a rendering related to the concept on an electronic display; code for collecting mental state data from a plurality of people as they are exposed to the concept wherein the mental state data comprises facial data; code for analyzing the mental state data to produce mental state information; and code for evaluating the concept based on the mental state information. In some embodiments, a computer system for concept evaluation may comprise: a memory which stores instructions; one or more processors attached to the memory wherein the one or more processors, when executing the instructions which are stored, are configured to: expose a plurality of people to a concept wherein the exposing includes displaying of a rendering related to the concept on an electronic display; collect mental state data from a plurality of people as they are exposed to the concept wherein the mental state data comprises facial data; analyze the mental state data to produce mental state information; and evaluate the concept based on the mental state information.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for affect-based concept testing.

FIG. 2 is a system diagram for capturing mental state data.

FIG. 3 is a graphical representation of mental state analysis.

FIG. 4 is a visualization including bee swarm eye focus.

FIG. 5 is a system diagram for evaluating mental states.

### DETAILED DESCRIPTION

The present disclosure provides a description of various methods and systems for affect-based evaluation of response to a concept, based on analyzing people's mental states, particularly when evaluating concept renderings. Viewers may observe concepts and have data collected on their mental states. Mental state data from a plurality of viewers may be processed to form aggregated mental state analysis which may be used in the projecting responses to concepts. Based on the projected response to a concept, the concept may be optimized. Computer analysis may be performed on facial and/or physiological data to determine mental states of the viewers as they observe various types of concepts. A mental state may be a cognitive state, an emotional state, or a combination thereof. Examples of emotional states may include happiness or sadness, while examples of cognitive states may include concentration or confusion. Observing, capturing, and analyzing these mental states can yield significant information about viewers' reactions to various stimuli.

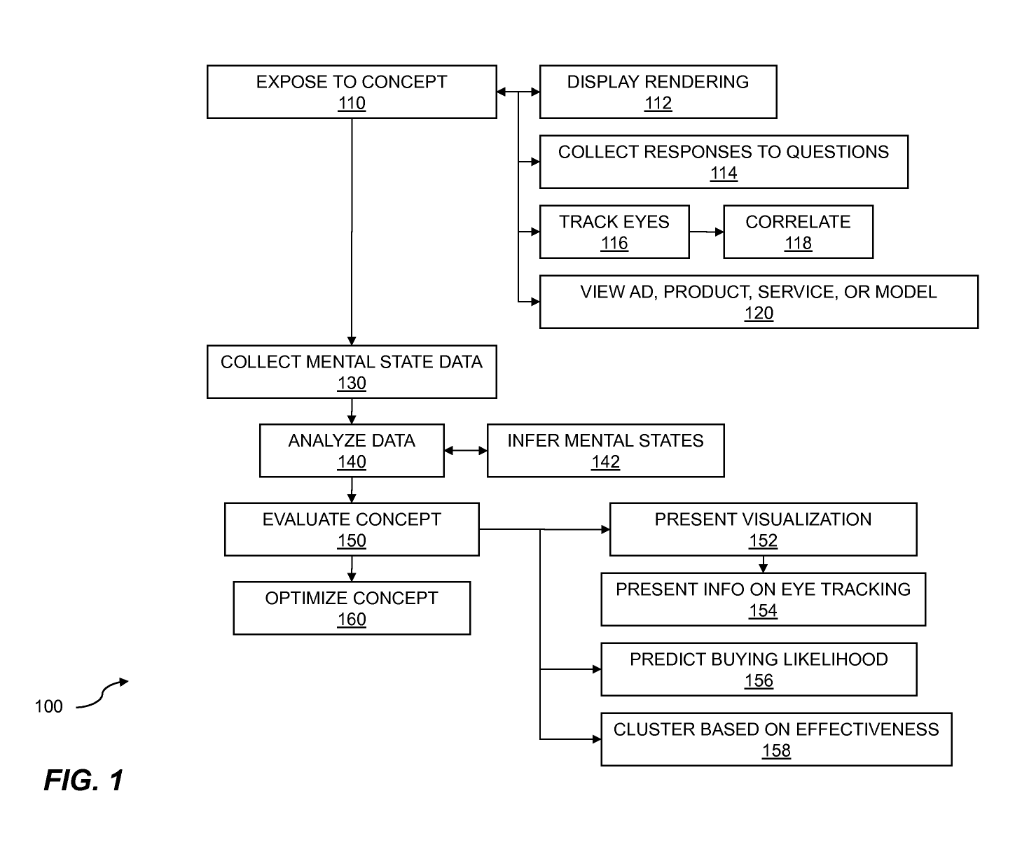

FIG. 1 is a flow diagram for concept testing. A flow 100 describes a computer-implemented method for concept evaluation. The evaluation may be based on analysis of viewer mental states. The evaluation may further be based on eye tracking The flow 100 may begin with exposing a person or a plurality of people to a concept 110 wherein the exposing may include displaying a rendering 112 related to a concept on an electronic display. The electronic display may be any electronic display, including but not limited to, a computer display, a laptop screen, a net-book screen, a tablet computer screen, a cell phone display, a mobile device display, a television, a projector, or the like. The concept may include a product, a service, a model, an advertisement, or the like. The concept may be shown to include messaging about the product or service where the message can include the material desired to be communicated to consumers. The messaging may include information on unique value, consumer benefit, the competitive landscape, and so on. The collecting of mental state data may be part of a concept evaluation process.

The rendering of a concept may include a series of images, a video, a series of sketches, an animatic, or the like. The rendering may comprise images, text, background, video, and the like. In embodiments, any or all these elements, a combination of multiple instances of these elements, or other elements may be present.

The flow 100 may include collecting responses to questions 114 as part of the process of exposing the viewers to a concept. The exposing may include collecting responses to questions about the concept from the plurality of people. Further, the responses collected may constitute self reporting, and the self reporting may be correlated to mental state data which has been collected. In some embodiments, mental state data is collected as the viewer responds to the questions. In embodiments, the mental state data is compared with the self-report data collected from the group of viewers. In this way, the analyzed mental states can be compared with the self-report information to see how well the two data sets correlate. In some instances, people may self-report a mental state other than their true mental state. For example, in some cases people may self-report a certain mental state because they feel it is the “correct” response, or they are embarrassed to report their true mental state. Such a comparison of self-report data and collected mental state data can serve to identify concepts where an individual or group's analyzed mental state deviates from their self-reported mental state.

The flow 100 may include tracking of eyes 116 for the plurality of people who are exposed to a concept. Tracking may include determining where in the concept window the viewer or viewers' eyes are focused. Tracking may further include dwell time of eyes on a particular location within a rendering. Eye tracking may be observed with a camera and may be used to identify portions of concept renderings viewers may find amusing, annoying, entertaining, distracting, or the like. Eye tracking may be accomplished with a camera such as a webcam, a camera on a computer (such as a laptop, a net-book, a tablet, or the like), a video camera, a still camera, a cell phone camera, a mobile device camera (including, but not limited to, a forward facing camera), a thermal imager, a CCD device, a three-dimensional camera, a depth camera, and multiple webcams used to capture different views of viewers or any other type of image capture apparatus that may allow image data captured to be used by an electronic system.

The flow 100 may include correlating mental state data 118 which has been collected with the portion of the rendering on which the eyes of a viewer or a plurality of viewers may have been focused. The mental state data may indicate a range of mental states of a viewer or a plurality of viewers of a concept rendering. The types of mental states that may be indicated may include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity, and the like. Some analysis may be performed on a client computer before the mental state data is uploaded. Analysis of the mental state data may take many forms, and may be based on one viewer or a plurality of viewers.

The flow 100 may include people viewing an advertisement, seeing a product, seeing a service, and seeing a model 120 as part of the exposing. The viewing of the product, service, model, or advertisement may be rendered on an electronic display. Alternatively, the viewing may be of a physical presentation or example of the product, service, model, or advertisement.

The flow 100 includes the collecting of mental state data 130 from a plurality of people as they are exposed to the concept wherein the mental state data may comprise facial data. Facial data may be obtained from video observations of a person. The facial data may include action units, head gestures, smiles, brow furrows, squints, lowered eyebrows, raised eyebrows, attention, and the like. The collecting of mental state data may also comprise collecting one or more of physiological data and actigraphy data. Physiological data may also be obtained from video observations of a person. For example, heart rate, heart rate variability, autonomic activity, respiration, and perspiration may be observed via video capture. Alternatively, in some embodiments, a biosensor is used to capture physiological information and may also be used to capture accelerometer readings. In some embodiments, permission is requested and obtained prior to the collection of mental state data. A viewer or plurality of viewers may observe a concept or concepts synchronously or asynchronously.

The flow 100 may continue with analyzing the mental state data 140 to produce mental state information. While mental state data may be raw data, mental state information may also include information derived from the raw data. The mental state information may include all of the mental state data or a subset thereof. The mental state information may include valence and arousal. The mental state information may include information on the mental states experienced by a viewer. Such analysis is based on the processing of mental state data from a plurality of people who observe the concept. Some analysis may be performed on a client computer before that data is uploaded, while some analysis may be performed on a server computer. Analysis of the mental state data may take many forms and may be based on one viewer or a plurality of viewers.

The flow 100 may include inferring mental states 142 about the concept based on the mental state data which was collected from a single viewer or a plurality of viewers wherein the mental states may include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, curiosity, and the like. The inferred mental states may be used to determine response to a concept. For example, one such inference might be that confusion, disappointment, hesitation, or cognitive overload corresponds to a lower measure of value for a concept. These mental states may be detected in response to viewing a complete concept rendering or a specific portion of a concept rendering.

The flow 100 continues with evaluating the concept 150 based on the collected mental state information and projecting possible responses. The projecting of a response to the concept may employ one or more descriptors and a classifier. The evaluating of the concept may include identification of demographics within the plurality of people to whom the concept was targeted. The evaluating may include comparing a group of concept presentations and may include determining which of these concept presentations meet desired objectives. Messaging may be evaluated where multiple messages are communicated. The presentation may be segmented based on message and evaluation of which messaging resonates with a desired consumer base may be determined. A concept may contain multiple messages and the messages may be presented as vignettes. The message vignettes may be ranked or sorted to determine the message vignette or vignettes which are most effective.

The flow 100 may include presenting a subset of the mental state information in a visualization 152. The presenting may be rendered on an electronic display; the electronic display may be any electronic display, including but not limited to, a computer display, a laptop screen, a net-book screen, a tablet computer screen, a cell phone display, a mobile device display, a television, a projector, or the like. In some embodiments, the visualization may be presented on a second electronic display where the concept is shown on one electronic display and the visualization about mental state information is presented on another electronic display. The visualization may include a concept rendering with images, text, background, video, and the like. The visualization may include thumbnails of the viewers, thumbnails of the concept rendering, or a combination thereof. A consumer profile may be determined based on the mental state data which was collected in light of the concept being presented. The consumer profile may include a graph showing a trend for a certain facial expression.

The flow 100 may include presenting information on tracking 154 viewers' eyes as they observe the visualization. In embodiments, data on tracking of eyes of a viewer or a plurality of viewers as they watch a concept rendering may be displayed in the visualization. One embodiment of such a visualization comprises a bee swarm display. Such a display may indicate on which portion of a concept rendering viewers eyes were focused, and may show whether eye focused shifted during viewing of the concept rendering. The eye focus may be shown on a moment-by-moment basis on the concept rendering.

The flow 100 may include predicting buying likelihood 156. Part of the evaluation process of a concept may include the prediction of a viewer's or a plurality of viewers' buying likelihood. Viewers may be presented with multiple concepts. The buying likelihood prediction may include evaluating, but is not limited to, which concept the viewer found most appealing and thus considered for purchase. Similarly, the buying likelihood prediction may include evaluating which concept the viewer found unappealing and thus less likely to be considered for purchase. In addition, other methods of predicting buying likelihood may be performed. Embodiments of the present invention may determine correlations between mental state and likely purchase behavior. Based on probabilities and other statistics derived from collected mental state data from viewers of a concept, the concept's value can be predicted. Information on actual eventual buying by consumers may be fed back into the evaluation process. This type of information along with other ground truth data about product performance and success in the marketplace can be used to improve the evaluation process and may be considered part of validation. The flow 100 may include evaluating where it includes clustering of the concept based on effectiveness 158. The clustering may indicate concepts which are effective or not effective in achieving a certain objective.

The flow 100 may continue with optimizing the concept 160 based on the mental state information. The concept may be optimized based on the mental state data gathered by a camera or other means from a viewer or a plurality of viewers. For example, a product's size, color, or shape might be modified to make the concept more appealing. Additional concepts, based on past experience, may have been labeled as being valuable or not. As mental state data is collected against these new concepts, the mental state data can be analyzed as described above to project concept value. A concept then may be optimized to, for example, maximize buying likelihood. Various steps in the flow 100 may be changed in order, repeated, omitted, or the like without departing from the disclosed inventive concepts.

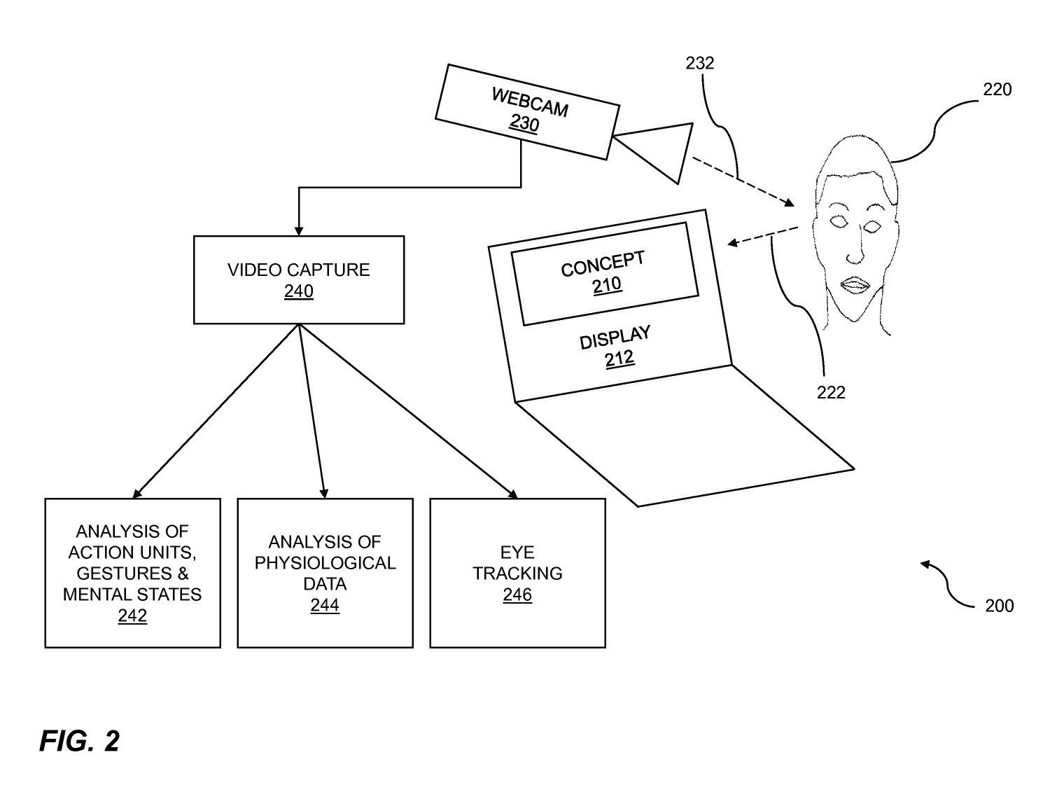

FIG. 2 is a system diagram for capturing mental state data in response to a concept 210. A viewer 220 has a line-of-sight 222 to a display 212. While one viewer has been shown, in practical use, embodiments of the present invention may analyze groups comprised of tens, hundreds, or thousands of people or more. Each viewer has a line of sight 222 to the concept 210 rendered on a display 212. The concept 210 may be a product concept, a service concept, a model concept, an advertisement concept, and so on. Multiple variations of the concept may be rendered on the display 212.

The display 212 may be a television monitor, computer monitor (including a laptop screen, a tablet screen, a net-book screen, and the like), projector, a cell phone display, a mobile device, or other electronic display. A webcam 230 is configured and disposed such that it has a line-of-sight 232 to the viewer 220. In one embodiment, the webcam 230 is a networked digital camera that may take still and/or moving images of the viewer's face 220 and possibly the viewer's body 220 as well. A webcam 230 may be used to capture one or more of the facial data and the physiological data.

The webcam 230 may refer to any camera including a webcam, a camera on a computer (such as a laptop, a net-book, a tablet, or the like), a video camera, a still camera, a cell phone camera, a mobile device camera (including, but not limited to, a forward facing camera), a thermal imager, a CCD device, a three-dimensional camera, a depth camera, multiple webcams used to show different views of the viewers or any other type of image capture apparatus that may allow captured image data to be used in an electronic system. The facial data from the webcam 230 is received by a video capture module 240 which may decompress the video into a raw format from a compressed format such as H.264, MPEG-2, or the like.

The raw video data may then be processed to obtain analysis of facial data, action units, gestures, mental states 242, and the like. The facial data may further comprise head gestures. The facial data itself may include information on one or more of action units, head gestures, smiles, brow furrows, squints, lowered eyebrows, raised eyebrows, attention, and the like. The action units may be used to identify smiles, frowns, and other facial indicators of mental states. Gestures may include tilting the head to the side, leaning forward, a smile, a frown, as well as many other gestures. Physiological data may be analyzed 244 and eyes may be tracked 246. Physiological data may be obtained through the webcam 230 without contacting the individual. Respiration, heart rate, heart rate variability, perspiration, temperature, and other physiological indicators of mental state can be determined by analyzing the images. The physiological data may also be obtained by a variety of sensors, such as electrodermal sensors, temperature sensors, and heart rate sensors.

Eye tracking 246 of a viewer or plurality of viewers may be performed. The eye tracking may be used to identify a portion of the concept on which the viewer is focused.

Further, in some embodiments, the process includes recording eye dwell time on the rendering and associating information on the eye dwell time to both the rendering and the mental states. The eye dwell time can be used to augment the mental state information by indicating the viewer or viewers' level of interest in certain renderings, portions of renderings, and the like. The webcam observations may include a blink rate for the eyes. For example, a reduced blink rate may indicate significant engagement in what is being observed.

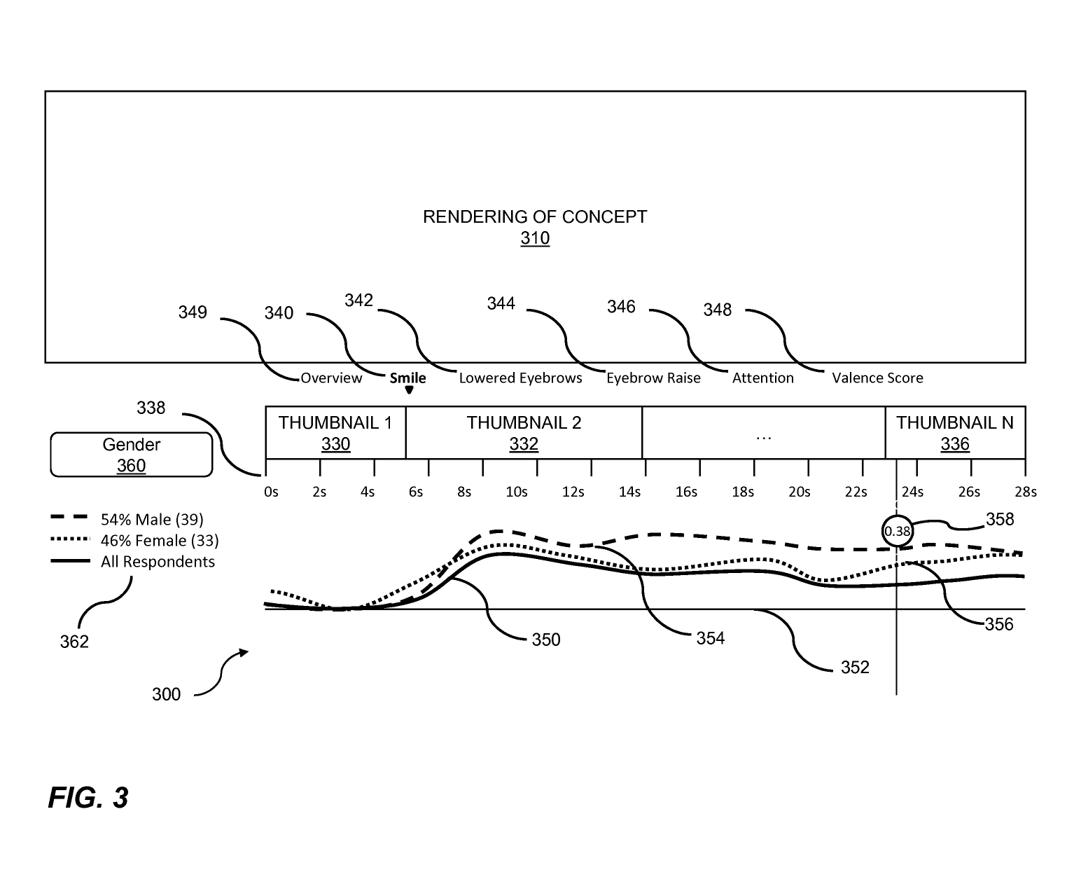

FIG. 3 is a graphical representation, which may be presented on an electronic display, of mental state analysis. This graphical representation may be shown for concept viewer analysis. The display may be a television monitor, projector, computer monitor (including a laptop screen, a tablet screen, a net-book screen, and the like), a cell phone display, a mobile device, or other electronic display. An example window 300 is shown which includes a rendering of a concept 310 along with associated mental state information. A user may be able to select among a plurality of concept renderings using various buttons and/or tabs. The user interface allows a plurality of parameters to be displayed as a function of time, synchronized to the concept rendering 310. Various embodiments may have any number of selections available for the user, and some may be other types of renderings instead of video. A set of thumbnail images for the selected rendering—in the example shown, Thumbnail 1 330, Thumbnail 2 332, through Thumbnail N 336—may be shown below the rendering along with a timeline 338. The thumbnails may show a graphic “storyboard” of the concept rendering. This storyboard may assist a user in identifying a particular scene or location within the concept rendering. Some embodiments do not include thumbnails, or have a single thumbnail associated with the rendering, while other embodiments have thumbnails of equal or different lengths. In some embodiments, the start and/or end of the thumbnails may be determined based on changes in the captured viewer mental states associated with the rendering or particular points of interest in the concept rendering. Thumbnails of one or more viewers may be shown along the timeline 338. The thumbnails of viewers may include peak expressions, expressions at key points in the concept rendering 310, and the like.

Some embodiments include the ability for a user to select a particular type of mental state information for display using various buttons or other selection methods. The mental state information may be based on one or more descriptors. The one or more descriptors may include, but are not limited to, one of AU4, AU12 and valence. For example, in the window 300 the smile mental state information is shown; the user may have previously selected the Smile button 340. Other types of mental state information that may be available for user selection in various embodiments include the Lowered Eyebrows button 342, Eyebrow Raise button 344, Attention button 346, Valence Score button 348 or other types of mental state information, depending on the embodiment. An Overview button 349 may be available and may allow a user to show graphs of the multiple types of mental state information simultaneously. The mental state information may include probability information for one or more descriptors, and the probabilities for the one of the one or more descriptors may vary for portions of the concept rendering.

Because, in the example shown, the Smile option 340 has been selected, a smile graph 350 is displayed against a baseline 352 showing the aggregated smile mental state information of the plurality of individuals from whom mental state data was collected for the concept. A separate male smile graph 354 and female smile graph 356 may be shown so that the visual representation displays the aggregated mental state information. The mental state information may be based on demographic data; information is collected as viewers who comprise a certain demographic react to the concept. The various demographic-based graphs may be indicated using various line types as shown or may be indicated using colors or other method of differentiation. A slider 358 may allow a user to select a particular time of the timeline and show the value of the chosen mental state for that particular time. The mental states can be used to evaluate the value of the concept.

In some embodiments, various types of demographic-based mental state information can be selected using the demographic button 360. Such demographics may include gender, age, race, income level, education, or any other type of demographic including dividing the respondents into those respondents that had higher reactions from those with lower reactions. A graph legend 362 may be displayed indicating the various demographic groups, the line type or color for each group, the percentage of total respondents and/or absolute number of respondents for each group, and/or other information about the demographic groups. The mental state information may be aggregated according to the demographic type selected. Thus, aggregation of the mental state information is performed on a demographic basis. In some embodiments, mental state information is also grouped on the demographic basis. Such a grouping is useful, for example, when a product or service developer may be interested in observing the mental state of a particular demographic group.

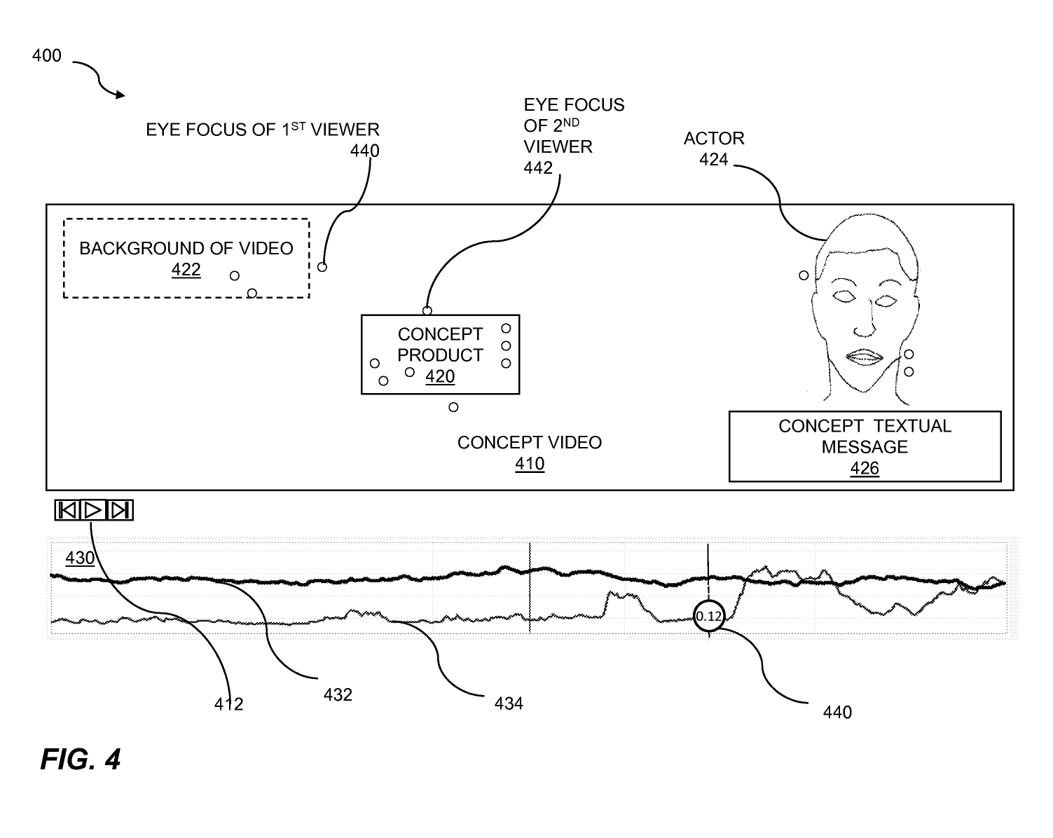

FIG. 4 is a visualization including bee swarm eye focus. A visualization diagram 400 including a concept video 410 and a mental state information graph 430 is shown. The visualization diagram 400 may be shown on an electronic display such as a television monitor, computer monitor (including a laptop screen, a tablet screen, a net book screen, and the like), a projector, a cell phone display, a mobile device, and the like. The concept video 410 may comprise one or more elements that may include a concept product 420, a background 422, an actor 424, and a concept textual message 426. In various embodiments, any or all of these elements may be present. In other embodiments, additional elements may be present. In embodiments, a plurality of viewers observes the concept video 410 as eyes are tracked for all, or a subset, of these viewers. The tracking of the eyes may identify a portion of the concept video or rendering on which the viewers' eyes are focused. The results of the eye tracking may be presented on the display as part of the visualization. In some embodiments, an eye tracking result presentation may be accomplished with a bee-swarm representation. The bee swarm may show information on the tracking of the eyes using dots, circle, or other shapes. The eye focus of a first viewer 440 is shown. The eye focus of a second viewer 442 is also shown. Each small circle in the concept video 410 may represent the focus of the eyes for one of the viewers. The location of the focus varies from moment to moment as the concept video 410 is played. In some embodiments, having viewers focus on the concept product 420 is considered ideal. In some cases, focusing on the concept textual message 426 is desirable. If viewers focus on the background of the video 422, the concept video 410 may not be considered valuable as this concept video 410 may be distracting from the product or message. The bee-swarm representation may include a demographic breakout 430 wherein differing demographic groups are represented using different shapes or colors. Further, the bee-swarm representation may include information on the mental state data of a user or a plurality of users. As before, differing mental state results may be shown with different shapes or colors. For example, a positive valence may be shown in green while a negative valence may be shown in red. In some embodiments, different symbols are used to represent different mental states. For example, a small smiley face may be used to denote a smile while a small frown face may be used to denote brow lowers. Other symbols and characters may be used to represent various mental states.

The visualization diagram 410 may include controls 412 on the video. The controls 412 may provide capability to stop, play, rewind, and fast forward the video. The bee-swarm representation may be modified so that it tracks with the video as the stop, play, rewind, and fast forward controls 412 are selected.

The mental state information graph 430 may allow for the comparison of graphs of various mental state parameters for a given user. In other embodiments, the visualization diagram 400 may further allow for the comparison of graphs of various mental state parameters for a plurality of viewers. For example, the mental state information graph 430 may include a graphical representation of two parameters, AU4 432 and AU12 434, for a given viewer. A slider 440 may allow a user to select a particular point in time on a timeline and show the value of a mental state probability for that particular time. In some embodiments, the concept video 410 is set to the point in time selected by the slider 440. The mental state information graph 430 may also show aggregated graphical representation of parameters for a plurality of users. In other embodiments, the graphical representation is a comparison of a given parameter for two different demographics. Various action unit graphs may be selected for display.

For example, a concept team may wish to test the value of a concept. A concept may be shown to a user or a plurality of viewers in a focus group setting. The concept team may notice an inflection point in one or more of the curves, such as a smile line, a lowered eyebrows line, a valence score, and the like. The concept team can then identify which part or parts of the concept visualization induced smiles from the viewers, or induced heightened concentration. Thus, a concept may be vetted by the concept team as being valuable or at least drawing a positive response. In this manner, viewer response can be obtained and analyzed.

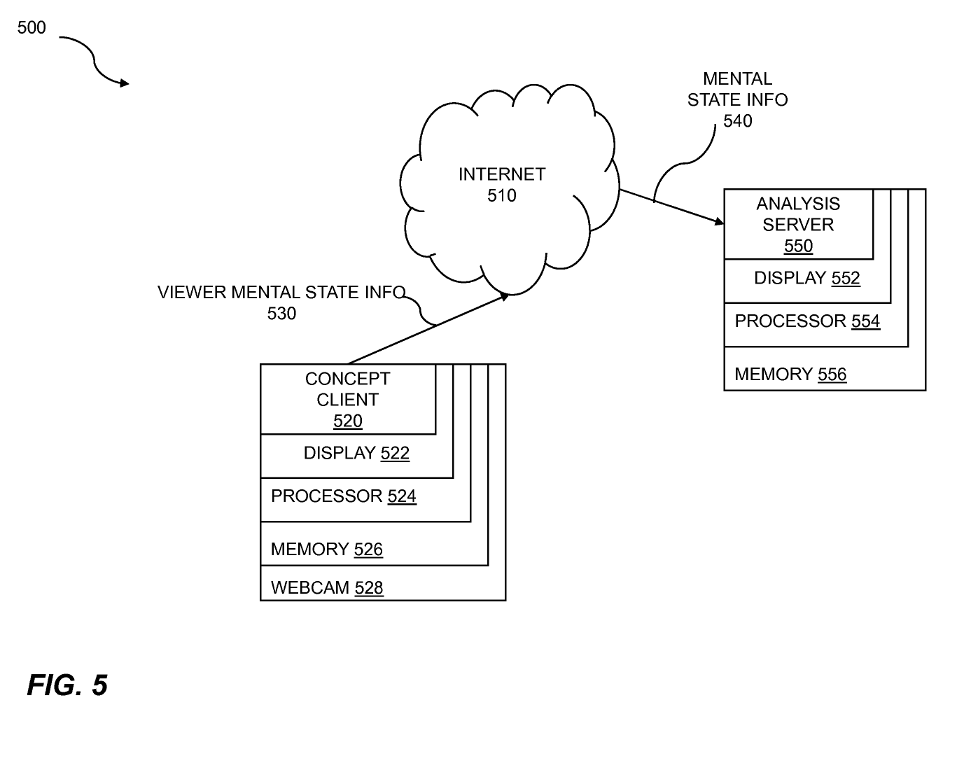

FIG. 5 is a system diagram for evaluating mental states. A system 500 may include a concept client machine 520 and an analysis server 550 as well as a connection between these machines. The Internet 510, intranet, or other computer network may be used for communication between or among the various computers. A concept machine or client computer 520 has a memory 526 which stores instructions, and one or more processors 524 coupled to the memory 526. The memory 526 may be used for storing instructions, for storing mental state data, for system support, and the like. The client computer 520 also may have an Internet connection to carry viewer mental state information 530 and a display 522 that may present various concepts to one or more viewers. The client computer 520 may be able to collect mental state data from one or more viewers as they observe the concept or concepts. In some embodiments, there are multiple client computers 520 that each collect mental state data from viewers as they observe a concept. The concept client computer 520 may have a camera 528, such as a webcam, for capturing viewer interaction with a concept including video of the viewer. The camera 528 may refer to a webcam, a camera on a computer (such as a laptop, a net-book, a tablet, or the like), a video camera, a still camera, a cell phone camera, a mobile device camera (including, but not limited to, a forward facing camera), a thermal imager, a CCD device, a three-dimensional camera, a depth camera, multiple webcams used to capture different views of viewers, or any other type of image capture apparatus that may allow image data captured to be used by the electronic system.

Once the mental state data has been collected, the client computer may upload information to a server or analysis computer 550, based on the mental state data from the plurality of viewers who observe the concept. The client computer 520 may communicate with the server 550 over the Internet 510, intranet, some other computer network, or by any other method suitable for communication between two computers. In some embodiments, the analysis computer 550 functionality may be embodied in the client computer.

The analysis computer 550 may have a connection to the Internet 510 to enable mental state information 540 to be received by the analysis computer 550. Further, the analysis computer 550 may have a memory 556 which stores instructions, data, help information and the like, and one or more processors 554 coupled to the memory 556. The analysis computer 550 may aggregate mental state information on the plurality of viewers who observe the concept.

The analysis computer 550 may process mental state data or aggregated mental state data gathered from a viewer or a plurality of viewers to produce mental state information about the viewer or plurality of viewers. In some embodiments, the analysis server 550 may obtain mental state information 530 from the concept client 520. In this case, the mental state data captured by the concept client 520 is analyzed by the concept client 520 to produce mental state information for uploading.

Based on the mental state information produced, the analysis server 550 may project a concept value based on the mental state information. The analysis computer 550 may also associate the aggregated mental state information with the rendering and also with the collection of norms for the context being measured.

In some embodiments, the analysis computer 550 may receive aggregated mental state information based on the mental state data from the plurality of viewers who observe the concept and may present aggregated mental state information in a rendering on a display 552. In some embodiments, the analysis computer may be set up for receiving mental state data collected from a plurality of viewers as they observe the concept in a real-time or near real-time embodiment. In at least one embodiment, a single computer incorporates the client, server, and analysis functionality. Viewer mental state data may be collected from the client computer or computers 520 to form mental state information on the viewer or plurality of viewers viewing a concept. The mental state information resulting from the analysis of the mental state date of a viewer or a plurality of viewers may be used to project a concept value based on the mental state information.

The system 500 may include a computer program product embodied in a non-transitory computer readable medium for concept evaluation including: code for exposing a plurality of people to a concept wherein the exposing includes displaying of a rendering related to the concept on an electronic display; code for collecting mental state data from a plurality of people as they are exposed to the concept wherein the mental state data comprises facial data; code for analyzing the mental state data to produce mental state information; and code for evaluating the concept based on the mental state information.

Each of the above methods may be executed on one or more processors on one or more computer systems. Embodiments may include various forms of distributed computing, client/server computing, and cloud based computing. Further, it will be understood that for each flowchart in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. Each element of the block diagrams and flowchart illustrations, as well as each respective combination of elements in the block diagrams and flowchart illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, by a computer system, and so on. Any and all of which implementations may be generally referred to herein as a “circuit,” “module,” or “system.”

A programmable apparatus that executes any of the above mentioned computer program products or computer implemented methods may include one or more processors, microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are not limited to applications involving conventional computer programs or programmable apparatus that run them. It is contemplated, for example, that embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized. The computer readable medium may be a non-transitory computer readable medium for storage.

A computer readable storage medium may be electronic, magnetic, optical, electromagnetic, infrared, semiconductor, or any suitable combination of the foregoing. Further computer readable storage medium examples may include an electrical connection having one or more wires, a portable computer diskette, a hard disk, a random access memory (RAM), a read-only memory (ROM), an erasable programmable read-only memory (EPROM), Flash, MRAM, FeRAM, phase change memory, an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the entity causing the step to be performed.

While the invention has been disclosed in connection with preferred embodiments shown and described in detail, various modifications and improvements thereon will become apparent to those skilled in the art. Accordingly, the spirit and scope of the present invention is not to be limited by the foregoing examples, but is to be understood in the broadest sense allowable by law.

What is claimed is:

1. A computer implemented method for concept evaluation comprising:
exposing a plurality of people to a concept wherein the exposing includes displaying of a rendering related to the concept on an electronic display;
collecting mental state data from a plurality of people as they are exposed to the concept wherein the mental state data comprises facial data;
analyzing the mental state data to produce mental state information; and
evaluating the concept based on the mental state information.

2. The method of claim 1 further comprising presenting a subset of the mental state information in a visualization.

3. The method of claim 2 wherein the visualization is presented on a second electronic display.

4. The method of claim 3 wherein the visualization further comprises the rendering related to the concept.

5. The method of claim 1 wherein the exposing further comprises collecting responses to questions about the concept from the plurality of people.

6. The method of claim 5 wherein the responses constitute self reporting and the self reporting is correlated to the mental state data which was collected.

7. The method of claim 1 further comprising tracking of eyes for the plurality of people who are exposed to the concept.

8. The method of claim 7 wherein the tracking of the eyes identifies a portion of the rendering on which the eyes are focused.

9. The method of claim 8 further comprising correlating the mental state data which was collected with the portion of the rendering on which the eyes were focused.

10. The method of claim 8 further comprising presenting information on the tracking of the eyes in a visualization.

11. The method of claim 10 wherein the presenting is accomplished with a bee-swarm representation of the information on the tracking of the eyes.

12. The method of claim 11 wherein the bee-swarm representation includes a breakout by demographics.

13. The method of claim 11 wherein the bee-swarm representation includes information on the mental state data.

14. The method of claim 1 wherein the rendering includes one of a series of images and a video.

15. The method of claim 1 wherein the evaluating includes prediction of buying likelihood.

16. The method of claim 1 wherein the evaluating includes identification of demographics, within the plurality of people, to target for the concept.

17. The method of claim 1 wherein the evaluating includes clustering of the concept based on effectiveness.

18. The method of claim 1 further comprising optimizing the concept based on the mental state information.

19. The method of claim 1 wherein the collecting mental state data further comprises collecting one or more of physiological data and actigraphy data.

20. The method of claim 19 wherein a webcam is used to capture one or more of the facial data and the physiological data.

21. The method of claim 1 further comprising inferring mental states about the concept based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity.

22. The method of claim 1 wherein the exposing further comprises viewing an advertisement, seeing a product, seeing a service, and seeing a model.

23. A computer program product embodied in a non-transitory computer readable medium for concept evaluation, the computer program product comprising:
code for exposing a plurality of people to a concept wherein the exposing includes displaying of a rendering related to the concept on an electronic display;
code for collecting mental state data from a plurality of people as they are exposed to the concept wherein the mental state data comprises facial data;
code for analyzing the mental state data to produce mental state information; and
code for evaluating the concept based on the mental state information.

24. A computer system for concept evaluation comprising:
a memory which stores instructions;
one or more processors attached to the memory wherein the one or more processors, when executing the instructions which are stored, are configured to:
expose a plurality of people to a concept wherein the exposing includes displaying of a rendering related to the concept on an electronic display;
collect mental state data from a plurality of people as they are exposed to the concept wherein the mental state data comprises facial data;
analyze the mental state data to produce mental state information; and
evaluate the concept based on the mental state information.
